(19) United States
(12) Patent Application Publication
(10) Pub. No.: US 2018/0133596 A1
(43) Pub. Date: May 17, 2018

(54) CONFIGURING TRANSLATION OF THREE DIMENSIONAL MOVEMENT

(71) Applicant: THOMSON Licensing, ISSY LES MOULINEAUX (FR)

(72) Inventors: Mark Francis RUMREICH, Indianapolis, IN (US); Krystle SWAVING, Los Angeles, CA (US); Arden ASH, Los Angeles, CA (US); Thomas Edward HORLANDER, Indianapolis, IN (US)

(73) Assignee: thomason Licensing

(21) Appl. No.: 15/565,831

(22) PCT Filed: Apr. 13, 2016
(86) PCT No.: PCT/US2016/027241

§ 371 Date: Oct. 11, 2017

Related U.S. Application Data
(60) Provisional application No. 62/147,641, filed on Apr. 15, 2015.

(51) Int. Cl. A63F 13/428; A63F 13/213

(52) U.S. Cl. CPC A63F 13/428; A63F 13/213

(57) ABSTRACT

Disclosed herein are an apparatus, method, and non-transitory computer readable medium for translating three dimensional movements. An interface is generated to permit configuration of at least one parameter for translating three dimensional movements. Three dimensional movement is detected and translated in accordance with the at least one parameter. A translation of the three dimensional movement is generated with a displayable moving image.

### BACKGROUND

Video game interfaces have evolved with the advent of motion gaming that permits users to interact with a video game through bodily movements. In such systems, input to the game may be spoken commands or bodily gestures.

### SUMMARY

As noted above, motion gaming permits interaction with video games through bodily movements. Virtual reality games may also allow users to navigate through various virtual scenes with gestures, such as swinging an arm or walking. However, a user playing a motion video game in a confined area may not have the physical space needed to make these large movements. Furthermore, large movements may be cumbersome for a user and may lead to fatigue. This may cause users to become irritated and give up playing the game.

In view of the foregoing, disclosed herein are an apparatus, method, and non-transitory computer readable medium for configuring three dimensional movement translations. In one aspect, an apparatus can comprise a sensor for generating information indicative of three dimensional movement of an object and a memory for storing at least on parameter. In a further aspect, the apparatus can comprise at least one processor configured to: receive from the sensor information indicative of three dimensional movement of the object; generate a displayable interface to permit configuration of at least one parameter for translating three dimensional movement of the object; store the at least one parameter in the memory; translate the three dimensional movement of the object in accordance with the at least one parameter; and generate an image corresponding to a translation of the three dimensional movement of the object with a displayable moving image.

In another example, the at least one processor can detect a control input comprising the at least one parameter and the at least one parameter can include an amplification parameter. In yet another example, the at least one processor can amplify movement of the moving image based at least partially on the amplification parameter and an acceleration of the three dimensional movement. In another aspect, the sensor can be a camera.

In yet another aspect, the at least one parameter can comprise at least one of a seat mode parameter, a telescoping arm action parameter, a non-linear motion parameter, a z-axis boost parameter, a motion hysteresis parameter, and a hand balance parameter.

In a further aspect, a method for configuring three dimensional movement translations can include: generating a displayable interface to permit configuration of at least one parameter for translating three dimensional movement; storing the at least one parameter in a memory; detecting three dimensional movement captured by a sensor; translating the three dimensional movement in accordance with the at least one parameter; and generating a translation of the three dimensional movement with a displayable moving image.

In yet another example, a non-transitory computer readable medium can have instructions therein which, upon execution, can cause at least one processor to: generate a displayable interface to permit configuration of at least one parameter for translating three dimensional movement; store the at least one parameter in a memory; detect three dimensional movement captured by a sensor; translate the three dimensional movement in accordance with the at least one parameter; and generate a translation of the three dimensional movement with a displayable moving image.

The aspects, features and advantages of the present disclosure will be appreciated when considered with reference to the following description of examples and accompanying figures. The following description does not limit the application; rather, the scope of the disclosure is defined by the appended claims and equivalents.

### BRIEF DESCRIPTION OF THE DRAWINGS

FIG. 1 is an example apparatus in accordance with aspects of the present disclosure.

FIG. 2 is a flow diagram of an example method in accordance with aspects of the present disclosure.

FIG. 3 is an example screenshot in accordance with aspects of the present disclosure.

FIG. 4 is a working example in accordance with aspects of the present disclosure.

### DETAILED DESCRIPTION

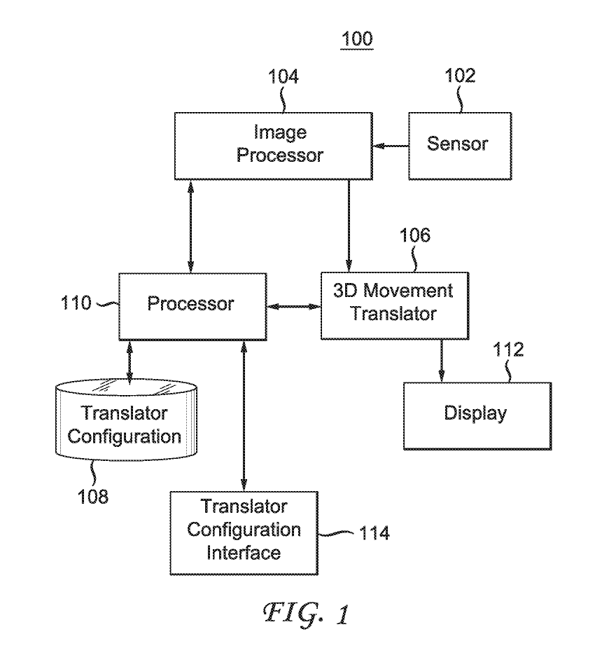

FIG. 1 shows a schematic diagram of an illustrative apparatus 100 for executing the techniques disclosed herein. Apparatus 100 can comprise any device capable of processing instructions and generating displayable images, including, but not limited to, a laptop, a full-sized personal computer, a smart phone, a tablet PC, a gaming console, and/or a smart television. Apparatus 100 can include at least one sensor 102 for detecting three dimensional movements and can have various other types of input devices such as pen-inputs, joysticks, buttons, touch screens, etc. In one example, sensor 102 can be a camera and can include, for example, complementary metal-oxide-semiconductor (“CMOS”) technology or can be a charge-coupled device (“CCD”). In another example, the camera can be a time-of-flight (“TOF”) camera that determines a real time distance between the camera and the subject in front of the camera based on the speed of light. The sensor can transmit sensed images and motion to image processor 104, which can comprise an integrated circuit for processing image signals. Such image processors can include an application-specific standard product (“ASSP”) or an application specific integrated circuit (“ASIC”). Image processor 104 can read the image as input; in turn, image processor 104 can output a set of characteristics associated with the image.

Processor 110 can provide further support for image processor 104. Processor 110 can include integrated circuitry for managing the overall functioning of apparatus 100. Processor 110 can also be an ASIC or a processor manufactured by Intel® Corporation or Advanced Micro Devices. Three dimensional (“3D”) movement translator 106 can comprise circuitry, software, or both circuitry and software for receiving image characteristic data derived by image processor 104. 3D movement translator 106 can translate this data in accordance with the configuration contained in translator configuration database 108. While only two processors are shown in FIG. 1, apparatus 100 can actually comprise additional processors and memories that may or may not be stored within the same physical housing or location. Although all the components of apparatus 100 are functionally illustrated as being within the same block, it will be understood that the components may or may not be stored within the same physical housing.

Although the architecture of translator configuration database 108 is not limited by any particular data structure, the data can be stored in computer registers, in a relational database as a table having a plurality of different fields and records, XML documents or flat files. The data can also be formatted in any computer-readable format. The data can comprise any information sufficient to identify the relevant information, such as numbers, descriptive text, proprietary codes, references to data stored in other areas of the same memory or different memories (including other network locations) or information that is used by a function to calculate the relevant data. As will be discussed in more detail further below, translation configuration interface 114 can be generated to permit a user to change the parameters of the movement translation. This interface can have a number of parameters that can alter the way the physical movement or gestures detected by the sensor are portrayed on a display. Translation configuration interface 114 can also be implemented in software, hardware, or a combination of software and hardware.

As noted above, 3D movement translator 106 and translation configuration interface 114 can also be implemented in software. In this instance, the computer readable instructions of the software can comprise any set of instructions to be executed directly (such as machine code) or indirectly (such as scripts) by processor 110. The computer executable instructions can be stored in any computer language or format, such as in object code or modules of source code. The instructions can be stored in object code format for direct processing by the processor, or in any other computer language including, but not limited to, scripts or collections of independent source code modules that are interpreted on demand or compiled in advance.

In a software implementation, the computer executable instructions of 3D movement translator 106 and translation configuration interface 114 can be stored in a memory (not shown) accessible by processor 110 including, but not limited to, a random access memory (“RAM”) or can be stored in a non-transitory computer readable medium. Such non-transitory computer readable medium can comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that can be coupled to apparatus 100 directly or indirectly. The medium can also include any combination of one or more of the foregoing and/or other devices as well.

Display 112 can include, but is not limited to, a CRT, LCD, plasma screen monitor, TV, projector, or any other electronic device that is operable to display information. Display 112 can be integrated with apparatus 100 or can be a device separate from apparatus 100. When the display 112 is a separate device, display 112 and apparatus 100 can be coupled via a wired or wireless connection. In one example, display 112 can be integrated with a head mounted display or virtual reality goggles used for virtual reality applications. In this instance, there can be a display for each eye to provide the user with a sense of depth.

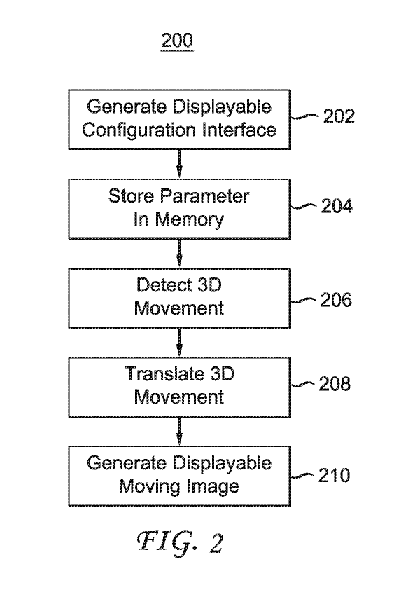

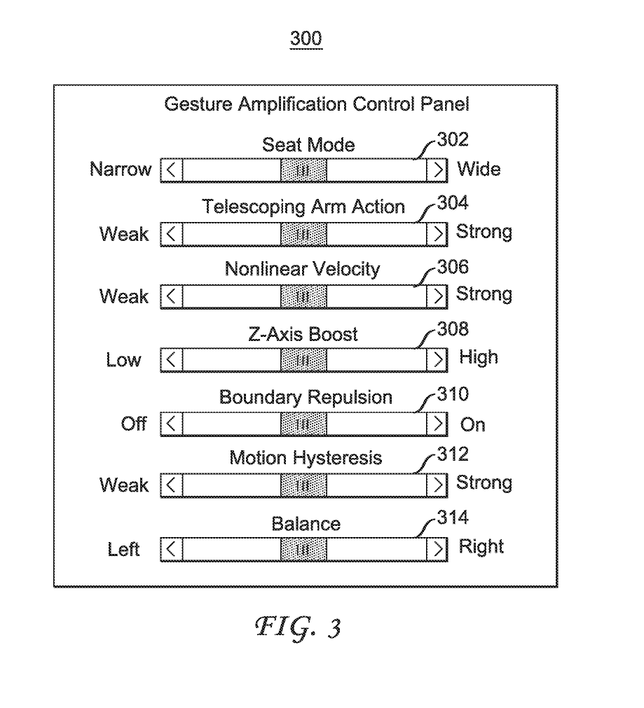

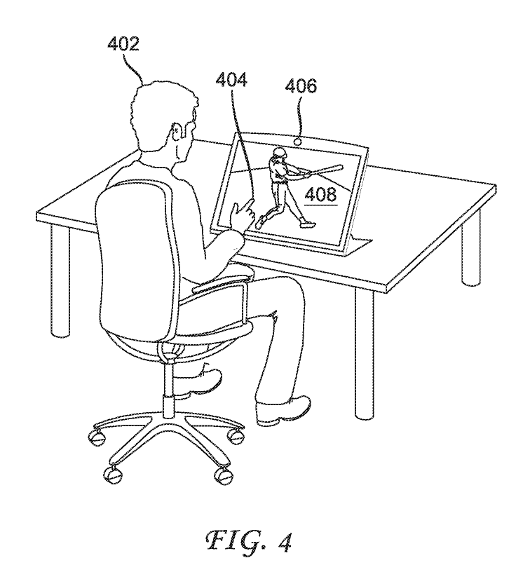

Working examples of the system, method, and non-transitory computer readable medium are shown in FIGS. 2-4. In particular, FIG. 2 illustrates a flow diagram of an example method 200 for translating 3D movements. FIGS. 3-4 show working examples in accordance with the techniques disclosed herein. The actions shown in FIGS. 3-4 will be discussed below with regard to the flow diagram of FIG. 2.

Referring to FIG. 2, a displayable configuration interface can be generated at block 202. This interface can be generated by the translation configuration interface 114 depicted in FIG. 1. Referring now to FIG. 3, an illustrative configuration interface 300 is shown displaying seven different example parameters that can be configured by a user. However, it should be understood that these parameters are merely illustrative and that any other relevant parameters can also be configurable. The parameters configured by the user can be stored in translator configuration database 108 of FIG. 1. The displayable screen can be shown on a display 112.

One example parameter shown in FIG. 3 is seat mode parameter 302. This parameter can be an amplification parameter that amplifies movements or gestures detected by sensor 102. That is, image processor 104 can provide 3D movement translator 106 with data associated with the detected movement and 3D movement translator 106 can amplify the movements in accordance with seat mode parameter 302. A user can configure this parameter to a narrower setting, when the user has little space to maneuver (e.g., on an economy seat of an airplane). Seat mode parameter 302 can be adjusted anywhere between a widest setting and a narrowest setting. A narrower setting permits smaller movement to be significantly enhanced on the screen. In particular, a small physical movement can translate into a large movement of a displayed object; in the case of virtual reality, a small physical movement can translate into a large virtual movement on the display. In one example, this setting changes the amplification of horizontal movements or movements along the X axis (e.g., left and right movements). Changes to this parameter allow a user to control a moving image on a screen without making significant movements that can disturb others nearby. If a user subsequently has more space, the user can configure the parameter to a wider setting. A wider setting decreases the amplification; in this instance, a user can need to make more significant movements to trigger large movements on the screen.

The telescoping arm action parameter 304 can be used to translate a fully extended physical arm of a user to a continuous expansion of a virtual arm on a display. The length of the expansion can be adjusted anywhere between a weak expansion and a strong expansion. This parameter can be effective in particular video game situations. For example, a strong expansion can allow a user to reach virtual objects that are well beyond the user's reach in the virtual workspace. Therefore, a stronger telescoping parameter setting can eliminate the need to reduce the size of the virtual workspace. In another example, this feature can be triggered by fully extending the arm and can be turned off by pulling the arm back. In yet a further example, the telescoping arm action parameter 304 can control the speed of the telescoping action or control the degree to which the user has to extend the arm to trigger the telescoping action. In the event the seat mode parameter is adjusted to a narrower setting, a small movement can trigger the telescoping feature. For example, a user can trigger the telescoping feature by fully extending the finger rather than the arm.

The non-linear velocity parameter 306 can be used for non-linear amplification of a movement's velocity. The configuration can allow a reference velocity to be set. When a user moves a body part at or below the reference velocity, the amplification of the velocity can be at or close to the actual velocity. In contrast, when the user moves a body part at a velocity greater than the configured reference velocity, the velocity can be amplified multiple times (e.g. three times) greater than the actual velocity. The reference velocity can be configured anywhere between a weakest reference velocity and a strongest reference velocity. If a high reference velocity is configured, the user can need to move faster to exceed the higher threshold and trigger the non-linear amplification. In a further aspect, the weaker or stronger setting can change the equation used in the amplification. By way of example, a change in the setting can change the slope or breakpoint in a piecewise-linear function. A function ƒ(x) can have a unity slope for small values of x, but a slope greater than one for larger values of x. In this example, the setting can change the high-value slope from unity to ten, or can change the x threshold where the slope changes from unity to ten. In yet another example, the weaker and stronger setting can change the N in the equation ƒ(x)=x^{N}. Thus, a very weak setting can be ƒ(x)=x¹ and a very strong setting can be ƒ(x)=x².

Also depicted in FIG. 3 is the Z-axis boost parameter 308. This parameter can allow a user to alter the translation of physical Z axis (e.g., forward/back) movement with respect to physical X-Y axis (e.g., left/right and up/down) movement. The Z-axis boost can be configured anywhere between a low boost and a high boost. This setting can be convenient in certain virtual reality games in which, due to the nature of the game, the physical Z-axis movement needs to be virtually enhanced more than the physical X-Y movement. As with the seat mode parameter, this feature allows a user to amplify movement in a confined space. In particular, the Z-axis boost parameter 308 can amplify physical Z-axis movements, when the physical Z-axis space is limited. Therefore, a user with limited Z-axis space can adjust the setting higher to translate small physical Z-axis movements to enhanced virtual Z-axis movements on the screen.

The boundary repulsion parameter 310 can be used to trigger repulsion between a moving image, such as a cursor, and the boundary of the virtual 3D space on the screen. The boundary of the virtual 3D space can be defined by, for example, how far a user can comfortably swing the arm in actual physical space. In the event the seat mode is adjusted to a narrower setting, the physical boundary can be narrower. In this instance, the virtual 3D space can be defined by, for example, how far a user can swing a finger, a hand, etc. This parameter can be used to help a user become accustomed to keeping movements within a camera's purview, since the moving image will be repelled by the virtual three dimensional boundaries, when the user moves outside the camera's purview.

The motion hysteresis parameter 312 can be configured to prevent an image on the screen from moving in response to slight inadvertent movements by a user. The motion hysteresis parameter can be adjusted anywhere between weak and strong. A stronger setting can prevent the image from moving in response to inadvertent movements; in this instance, an image can move in response to physical movement, if the physical movement surpasses a threshold. A weaker setting (e.g., 0 hysteresis) can render the moving image sensitive to even the slightest movements, such as an inadvertent shaking of the hand. The threshold can be a distance or velocity threshold.

The balance parameter 314 can be configured to bias the amplification of a movement to a particular side. This parameter can be configured if, for example, a user has more space on the left than on the right; in this instance, the user can bias the balance parameter toward the left. The same can be done with the right side.

Referring back to FIG. 2, in block 204, the configured parameters can be stored in a memory, such as in translator configuration database 108. Once the parameters are stored, they can be ready for processing by 3D movement translator 106. In block 206, 3D movement can be detected. Referring now to FIG. 4, a user 402 is shown moving a finger 404 some distance away from apparatus 410. In this working example, apparatus 410 is integrated with a display 408. The movement of the finger 404 can be detected by camera 406. Characteristics of the finger movement can be extracted by image processor 104. Such characteristics can include, but are not limited to, a distance of the finger from the camera, the length of the finger, the shape of the finger, the velocity of the finger's movement, etc. This information can be forwarded to 3D movement translator 106, which can read data from translator configuration database 108, in response to receiving the characteristic information.

Referring back to FIG. 2, the 3D movement can be translated, as shown in block 208. A displayable moving image can be generated at block 210 so as to translate the detected 3D movement. Referring again to FIG. 4, an example moving image of a baseball player swinging a bat is shown on display 408. The bat image can be swung in accordance with the movement of finger 404. Rather than making a full swinging movement, user 402 can control the swinging bat on the screen with a slight movement of finger 404. In this example, the small movement can be amplified in accordance with seat mode parameter 302. Other parameters can also affect the translation of the swinging bat, such as motion hysteresis parameter 312, non-linear velocity parameter 306, and/or balance parameter 314. In this working example, a user can adjust the settings until an optimal setting for swinging the bat is found; alternatively, the game can automatically adjust the settings for an optimal swing. It is understood that the example baseball player image of FIG. 4 is merely illustrative and that many other types of images can be used to translate various movements (e.g., virtual reality images).

Advantageously, the above-described apparatus, non-transitory computer readable medium, and method allow a user to configure various parameters for 3D motion. In this regard, a user can configure, for example, the amplification of a motion so that large movements on the screen can be triggered with small physical movements. In turn, users playing a game in a confined space can avoid disturbing others around them. Furthermore, users can enjoy generating large movements on the screen without fatigue.

Although the disclosure herein has been described with reference to particular examples, it is to be understood that these examples are merely illustrative of the principles of the disclosure. It is therefore to be understood that numerous modifications can be made to the examples and that other arrangements can be devised without departing from the scope of the disclosure as defined by the appended claims. Furthermore, while particular processes are shown in a specific order in the appended drawings, such processes are not limited to any particular order unless such order is expressly set forth herein. Rather, various steps can be handled in a different order or simultaneously, and steps can be omitted or added.

1. An apparatus comprising:
a sensor for generating information indicative of three dimensional movement of an object;
at least one processor configured to:
receive from the sensor information indicative of three dimensional movement of the object;
generate a displayable interface to permit configuration of at least one parameter for translating three dimensional movement of the object;
wherein said at least one parameter comprises a component based at least partially on an acceleration of a three dimensional movement;
translate the three dimensional movement of the object in accordance with the at least one parameter; and
generate an image corresponding to a translation of the three dimensional movement of the object with a displayable moving image.

2. The apparatus of claim 1, wherein the at least one processor is configured to detect a control input comprising the at least one parameter.

3. The apparatus of claim 1, wherein the at least one parameter comprises an amplification parameter.

4. The apparatus of claim 3, wherein the at least one processor is further configured to amplify movement of the moving image based at least partially on the amplification parameter.

5. The apparatus of claim 4, wherein the at least one processor is further configured to amplify movement of the moving image based at least partially on an acceleration of the three dimensional movement.

6. The apparatus of claim 1, wherein the sensor is a camera.

7. The apparatus of claim 1, wherein the at least one parameter comprises at least one of a seat mode parameter, a telescoping arm action parameter, a non-linear motion parameter, a z-axis boost parameter, a motion hysteresis parameter and a balance parameter.

8. A method comprising:
generating, by at least one processor, a displayable interface to permit configuration of at least one parameter for translating three dimensional movement;
detecting, by the at least one processor, three dimensional movement captured by a sensor;
translating, by the at least one processor, the three dimensional movement in accordance with the at least one parameter; wherein said at least one parameter comprises a component based at least partially on an acceleration of a three dimensional movement;
and
generating, by the at least one processor, a translation of the three dimensional movement with a displayable moving image.

9. The method of claim 8, further comprising detecting, by the at least one processor, a control input containing the at least one parameter for translating the three dimensional movement.

10. The method of claim 8, wherein the at least one parameter comprises an amplification parameter.

11. The method of claim 10, further comprising amplifying, by the at least one processor, movement of the moving image based at least partially on the amplification parameter.

12. The method of claim 11, wherein amplifying movement of the moving image is based at least partially on an acceleration of the three dimensional movement.

13. The method of claim 8, wherein the sensor is a camera.

14. The method of claim 8, wherein the at least one parameter comprises at least one of a seat mode parameter, a telescoping arm action parameter, a non-linear motion parameter, a z-axis boost parameter, a motion hysteresis parameter, and a balance parameter.

15. A non-transitory computer readable medium having instructions therein which upon execution cause at least one processor to:
generate a displayable interface to permit configuration of at least one parameter for translating three dimensional movement;
detect three dimensional movement captured by a sensor;
translate the three dimensional movement in accordance with the at least one parameter; wherein said at least one parameter comprises a component based at least partially on an acceleration of a three dimensional movement;
and
generate a translation of the three dimensional movement with a displayable moving image.

16. The non-transitory computer readable medium of claim 15, wherein, upon execution, the instructions stored therein further instruct at least one processor to detect a control input comprising the at least one parameter for translating the three dimensional movement.

17. The non-transitory computer readable medium of claim 15, wherein the at least one parameter comprises an amplification parameter.

18. The non-transitory computer readable medium of claim 17, wherein, upon execution, the instructions stored therein further instruct at least one processor to amplify movement of the moving image based at least partially on the amplification parameter.

19. The non-transitory computer readable medium of claim 18, wherein, upon execution, the instructions stored therein further instruct at least one processor to amplify the movement of the moving image based at least partially on an acceleration of the three dimensional movement.

20. The non-transitory computer readable medium of claim 15, wherein the sensor is a camera.
